(19) United States
(12) Patent Application Publication
(10) Pub. No.: US 2009/0313583 A1
(43) Pub. Date: Dec. 17, 2009

(54) SYSTEM AND METHOD FOR ASSOCIATING FUNCTIONS OF AN ELECTRONIC DEVICE

(75) Inventor: PI-FENG SHIH, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/332,332

(22) Filed: Dec. 10, 2008

(30) Foreign Application Priority Data
Jun. 13, 2008 (CN) 200810302127.3

(51) Int. Cl. G06F 3/048

(52) U.S. Cl. 715/841

(57) ABSTRACT

A system and method for associating functions of an electronic device comprises setting one or more associated functions and storing the associated functions onto a storage system of the electronic device, searching the storage system and determining if there are functions associated with a selected function, and displaying sub-options of the selected function as well as the functions associated with the selected function.

### BACKGROUND

1. Technical Field

Embodiments of the present disclosure relate to associating information, especially a system and method for associating functions of an electronic device.

2. Description of Related Art

As society moves forward, mobile devices, such as mobile telephones, smart phones, personal data assistants (PDAs), etc. are being used and depended upon more and more in everyday life. Today, it is common for a person to have a mobile telephone, PDA, laptop, and a personal computer. These devices typically include one or more applications which allow a user to send/receive e-mail, draft documents, maintain contacts, maintain schedules, organize finances, etc. The portability and usability of these mobile devices allow a user to perform many tasks which tends to promote greater efficiency and productivity.

However, while mobile computing devices have changed many lives for the better, there are some drawbacks, partly due to the large amount of data and applications that can be stored on the devices. For example, due to the large number of available applications on an electronic device, it can be tedious for a user to find certain data that may not be available through one or more applications that the user is currently using. Searching through multiple applications and lists of data items stored on the mobile device can be cumbersome, which tends to lead to inefficiencies such as repetitive actions.

What is needed, therefore, is a system and method for associating functions of an electronic device to overcome the above-stated problems.

### BRIEF DESCRIPTION OF THE DRAWINGS

FIG. 1 is a block diagram of one embodiment of an electronic device including a function associating system;

FIG. 2 is a flowchart of one embodiment of a method for associating functions by using the mobile device; and

FIG. 3 is a schematic block diagram of an interface displaying associated functions.

### DETAILED DESCRIPTION OF CERTAIN INVENTIVE EMBODIMENTS

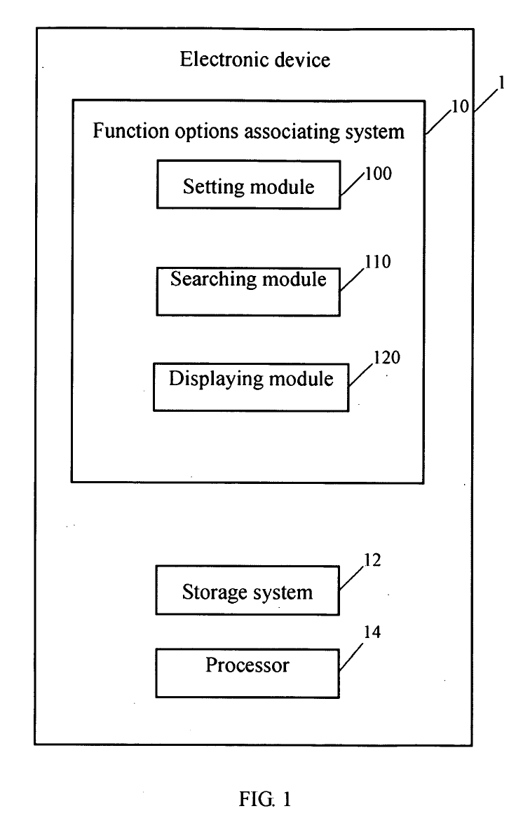

FIG. 1 is a block diagram of one embodiment of an electronic device 1 including a function associating system 10 (hereinafter “the system 10”). The electronic device 1 may be a mobile phone, a personal digital assistant (PDA), or an MPEG-1 Audio Layer 3 (MP3) player depending on the embodiment, but the present disclosure is not limited thereto. The system 10 is used for displaying associated functions in an interface provided by the electronic device 1 to allow convenient selection of functions by users. The system 10 includes a setting module 100, a searching module 110, a displaying module 120. A more detailed explanation of various functions and associated functions will be explained herein below.

The electronic device 1 further includes a storage system 12 for storing various kinds of data and programs used or generated by the system 10, including regarding the association of groups of functions. The storage system 12 may be an internal memory card or an external memory card. The external memory card may be a smart media card (SMC), a secure digital card (SDC), a compact flash card (CFC), a multi media card (MMC), a memory stick (MS), a extreme digital card (XDC), and a trans flash card (TFC).

The electronic device 1 may further includes a processor 14, which is used for executing one or more operations for the setting module 100, the searching module 110, and the displaying module 120.

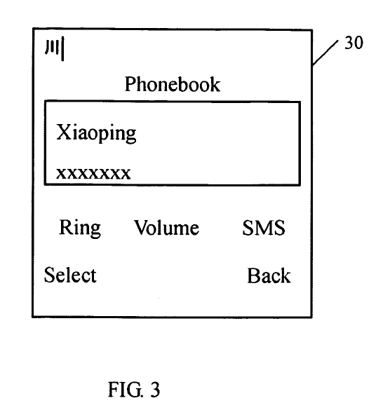

The setting module 100 is configured for setting associations among related functions so that when a user selects one function using an interface of the electronic device 1, other functions associated with the selected function will become obvious and available for selection. For example a menu of functions may be presented by the displaying module 120, when a user selects one item by means, such as the press of a button or a touch to the screen, other related items will appear in a sub-menu or become highlighted in a display 30 (shown in FIG. 3). The setting module 100 stores the settings of associated functions in the storage system 12. In one embodiment, a grouping or association of functions such as, “ring,” “volume,” “SMS,” associated with a “phonebook” function (shown in FIG. 3).

The searching module 110 is configured for accessing the storage system 12 and determining if there are functions associated with a selected function. For example, if a user selects a function named “phonebook,” then the searching module 110 accesses the storage system 12 and determines if there are functions associated with the phonebook function, such as “ring,” “volume,” or “SMS,” according to the settings function stored in the storage system 12.

The displaying module 120 is configured for displaying the sub-menus of the selected function and the associated functions if there are associated functions; and further configured for displaying sub-options of the associated functions if the user selects one of them over one of the sub-options of the originally selected function.

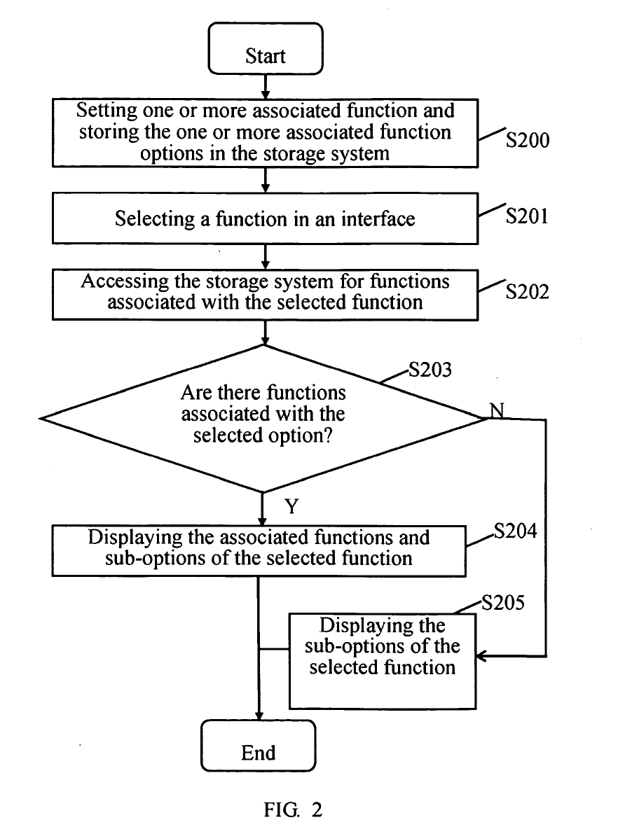

FIG. 2 is a flowchart of one embodiment of a method for associating functions by using the electronic device 1 in FIG. 1. Depending on the embodiment, additional blocks may be added, others deleted, and the ordering of the blocks may be changed. In block S200, the setting module 100 sets one or more groups of associated functions and stores the settings function in a storage system 12 of the electronic device 1.

In block S201, a user selects a function using an interface provided by the electronic device 1. For example, the user select a function named “phonebook.”

In block S202, the searching module 110 accesses the storage system 12 for associated functions of the function phonebook.

In block S203, the searching module 110 checks if there are functions associated with the selected function and sends the result to the displaying module 120. In FIG. 3, the searching module 110 checks if there are functions associated with the selected function “phonebook”, and sends the checking result to the displaying module 120. As mentioned above, the associated functions may include such as “ring,” “volume,” or “SMS.”

In block S204, the displaying module 120 displays sub-options of the selected function as well as functions associated with the selected function, if any. For example, if a user is going to make a phone call, he/she needs to access an address book. He/she finds the name “Xiaoping” and the phone number for Xiaoping. Some associated functions with the phone number are a ring, volume, SMS, and etc. The user may select one of the phone number of “Xiaoping” to dial, or choose one of the presented associated functions “ring,” “volume,” or “SMS.”

In block S205, the displaying module 120 displays sub-options of the selected function if there is not any function associated with the selected functions. The user may choose a sub-option and the process ends and the sub-option is executed.

FIG. 3 is a schematic block diagram of an interface displaying associated functions. Menus of functions may be presented by the displaying module 120, when a user selects one item by means, such as the press of a button or a touch to the screen, other related items will appear in a sub-menu or become highlighted in a display 30. In one embodiment, a grouping or association of functions such as, “ring,” “volume,” “SMS,” may be associated with a “phonebook” function.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computer-implemented method for associating functions of an electronic device, the method comprising:
setting a set of one or more associated functions of the electronic device;
storing the set one or more associated functions in a storage system of the electronic device;
selecting a function in an interface provided by the electronic device, wherein the function is selected from the set of one or more associated functions;
accessing the storage system and determining if there are functions from the set of the one or more associated functions that are associated with the selected function; and
displaying sub-options of the selected function and the functions associated with the selected function onto a display of the electronic device.

2. The method as claimed in claim 1, wherein the electronic device is selected from a group consisting of a mobile phone, a personal digital assistant (PDA), and an MPEG-1 Audio Layer 3 (MP3) player.

3. A system for associating functions of an electronic device, the system comprising:
a processor operable to execute computer program instructions; and
a storage system operable to store computer program instructions executable by the processor, for performing a method of:
setting a set of one or more associated functions of the electronic device;
storing the set one or more associated functions in the storage system;
selecting a function in an interface provided by the electronic device, wherein the function is selected from the set of one or more associated functions;
accessing the storage system and determining if there are functions from the set of the one or more associated functions that are associated with the selected function; and
displaying sub-options of the selected function and the functions associated with the selected function onto a display of the electronic device.

4. The system as claimed in claim 3, wherein the electronic device is selected from a group consisting of a mobile phone, a personal digital assistant (PDA), and an MPEG-1 Audio Layer 3 (MP3) player.

5. A storage medium having stored thereon instructions that, when executed by an electronic device, cause the electronic device to perform a method for associating functions, the method comprising:
setting a set of one or more associated functions of the electronic device;
storing the set one or more associated functions in a storage system of the electronic device;
selecting a function in an interface provided by the electronic device, wherein the function is selected from the set of one or more associated functions;
accessing the storage system and determining if there are functions from the set of the one or more associated functions that are associated with the selected function; and
displaying sub-options of the selected function and the functions associated with the selected function onto a display of the electronic device.

6. The storage medium as claimed in claim 5, wherein the electronic device is selected from a group consisting of a mobile phone, a personal digital assistant (PDA), and an MPEG-1 Audio Layer 3 (MP3) player.
